(19) United States
(12) Patent Application Publication
(10) Pub. No.: US 2004/0095951 A1
(43) Pub. Date: May 20, 2004

(54) Digital filter of a mobile communication system and operating method thereof

(75) Inventor: Won-Hyoung Park, Gyeonggi-Do (KR)

Correspondence Address: FLESHNER & KIM, LLP, P.O. BOX 221200, CHANTILLY, VA, 20153, US

(73) Assignee: LG Electronics Inc.

(21) Appl. No.: 10/653,154

(22) Filed: Sep. 3, 2003

(30) Foreign Application Priority Data
Oct. 30, 2002 (KR) 66655/2002

(51) Int. Cl. H04J 3/16

(52) U.S. Cl. 370/437; 370/535

(57) ABSTRACT

A digital filter of a mobile communication system and an operating method thereof for processing digital signals inputted through plural channels: a first switch outputting digital signals, which are inputted through a plurality of channel paths, in a predetermined order with multiple rate; a filter unit processing signals inputted from the first switch in a poly-phase method; a second switch outputting output signals of the filter unit after dividing them by channels; and a clock unit for supplying clock signals to the first switch, the filter unit and the second switch. The digital filter of multi-channels can be integrated/miniaturized with one component and the filter processing rate can be improved.

### BACKGROUND OF THE INVENTION

1. Field of the Invention

The present invention relates to a digital filter of a mobile communication system, and more particularly, to a digital filter of a mobile communication system designed as a multi-channel and multi-phase interpolation configuration and an operating method thereof

2. Background of the Related Art

Recently, a communication network is being developed as a systematic wireless structure which is able to process all services an enhance information transfer. Research is on-going for next-generation mobile communication technology in which a voice-centered mobile communication technology is able to transmit characters, images and multimedia information as well as the voice. This makes communication possible anywhere on the planet through active performances of international roaming.

A filter for filtering digital signals of baseband on a transmission path of a base station is referred to as a pulse shaping filter (PSF). The digital filter can be divided into an infinite impulse response (IIR) filter which feeds-back output into input, and a finite impulse response (FIR) filter which does not feed-back the output into the input.

Generally, the digital filter processes bits by multiplying the bit by a coefficient. This requires a register for temporarily storing respective data processed by bit units. In addition, the digital filter shows higher filtering characteristic as degree or tap becomes higher. Therefore, a digital filter having higher filtering characteristic needs more registers and logic gates. Processing rate of the digital filter is represented as chip unit, and one chip is 3.84 Mbps. In addition, there is an interpolation means and process for improving the chip rate.

FIG. 1 is a view showing a configuration of an integrated type FIR filter according to the related art. As shown therein, the FIR filter comprises: a plurality of multipliers 11 for multiplying inputted data by a corresponding coefficient; a plurality of registers 12 for storing data processed by the multiplier 11 and outputting the respective data according to a corresponding clock; and an adder 13 for adding the data outputted from the register 12 and the data outputted from the multiplier 11.

The integrated type FIR filter has a simple configuration. However, the filter is extended to be as long as the number of degree or the tap and may consume a lot of processing time. Also, the integrated type FIR filter has some problems, for example, volume becomes larger and price becomes expensive.

For example, the integrated type FIR digital filter filtering with 64 taps and having the input data of 14 bits requires 896 1 bit multipliers, 896 1 bit registers and 896 1 bit adders. This configuration causes the volume to grow larger and increases the price. This takes a lot of processing time, since the data is outputted after passing through all the logic gates.

A sub (or poly-phase) type FIR digital filter solves some of the problems of the integrated type FIR digital filter, and FIG. 2 is a view showing a configuration of the sub-type FIR digital filter according to the related art.

As shown in FIG. 2, the digital filter comprises: four sub-filters 21 for filtering inputted digital signals in a predetermined order; a plurality of accumulators 22 for accumulating results outputted from the respective sub-filters 21; and a switch 23 for outputting the signals accumulated by the plurality of accumulators 22 after selecting them in a predetermined order.

The sub-type FIR digital filter processes a digital input signal of 14 bits having 1 chip rate with 64 taps, and includes four sub-filters 21 filtering 16 taps respectively. The results of the filtering by the respective sub-filters 21 are accumulated on the accumulators 22, and the data of the accumulators 21 are outputted as digital signals of 14 bits which are filtered by the switch 23 after reading with 4 chips rate.

That is, the sub-type FIR digital filter as above filters the inputted bit signals using the four sub-filters 22 by 16 taps, and therefore, the processing rate can be improved 4 times faster than that of the related art.

However, the sub-type FIR digital filter effectively filters the data inputted through one channel or one path. However, in a case where the data is inputted through a plurality of channels or a plurality of paths, a lot of logic gates for processing them are required.

Also, a high integration sub-type FIR filter uses a logic gate having a higher capacity and a higher rate, however, final processing rate is limited. Therefore, there is a limit in the processing rate of the digital filter for processing the signals of multi-channels or the multi-paths.

In addition, in order to process the signals of the plural channels or the plural paths simultaneously by the sub-type FIR filter, a plurality of sub-type FIR digital filters should be used. Therefore, the volume of the digital filter becomes much greater and the resulting price of the filter is raised.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

One exemplary embodiment of the present invention is to provide a digital filter of a mobile terminal and an operational method thereof which is able to process signals of a plurality of channels with one sub-type FIR digital filter by configuring respective sub-filters of the sub-type FIR digital filter filtering the digital signals as integrated type FIR digital filters of same configuration.

To achieve the object of the present invention, as embodied and broadly described herein, there is provided a digital filter of a mobile communication system comprising: a first switch outputting digital signals inputted through a plurality of channel paths in a predetermined order with multiple rates; a filter unit for processing the signals inputted from the first switch in a poly-phase method; a second switch for outputting the output signal of the filter unit after dividing them by channels; and a clock unit for supplying clock signals to the first switch, the filter unit and the second switch.

In another embodiment of the present invention, a digital filter of a mobile communication system comprises: a first switch outputting digital signals, which are inputted through a plurality of channel paths in channel units, with multiple rates after interpolating the signals; a filter unit including a plurality of sub-filters processing the digital signals inputted from the first switch in a poly-phase method; a second switch outputting output signals of an adder after re-arranging the signals by channels; and a clock unit supplying multiple clock signals to the first switch, the filter unit and to the second switch.

In another embodiment of the present invention a digital filter of a mobile communication system comprises: a first switch for interpolating digital signals inputted through a plurality of channels with ×1 chip rate and outputting them after arranging in parallel sequentially; a plurality of registers for storing and shifting the digital signal inputted from the first switch; a plurality of multiplier for multiplying signals inputted to respective channels from the registers by corresponding coefficient; an adder for adding output signals of the multipliers; a second switch re-arranging output signals of the adder by channels and outputting them; and a clock unit supplying clock signal of N chip rate (N is 1 or larger natural number) in order to process the digital signal.

There is provided an operating method of a digital filter for filtering digital signals inputted through a plurality of channels in a poly-phase method based on a clock signal supplied in the multiple rates.

Also, there is provided an operating method of a digital filter comprising: a step of inputting respective digital signals through a plurality of channels; a step of filtering the inputted digital signals in poly-phase method; and a step of re-arranging the filtered digital signal by channels and outputting them.

And there is also provided an operating method of a digital filter comprising: a step of inputting respective digital signals into a first switch through a plurality of channels; a step of interpolating and outputting the digital signals inputted by channels; a step of filtering the interpolated digital signals in poly-phase method by repeatedly inputting the signals; and a step of dividing and outputting the filtered digital signals by channels in a second switch.

The foregoing and other features, aspects and advantages of the present invention will become more apparent from the following detailed description of the present invention when taken in conjunction with the accompanying drawings.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing a configuration of an integrated type FIR digital filter according to the related art;

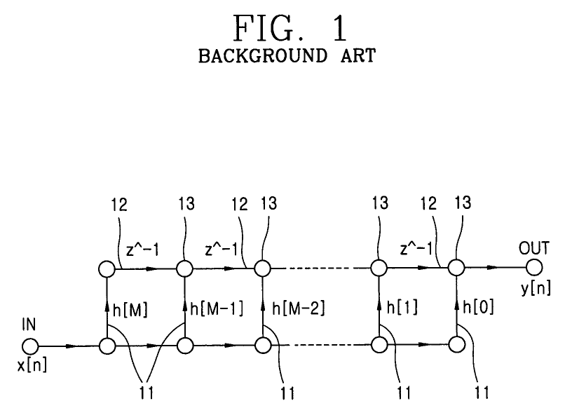

FIG. 2 is a block diagram showing a configuration of a sub-type FIR digital filter according to the related art;

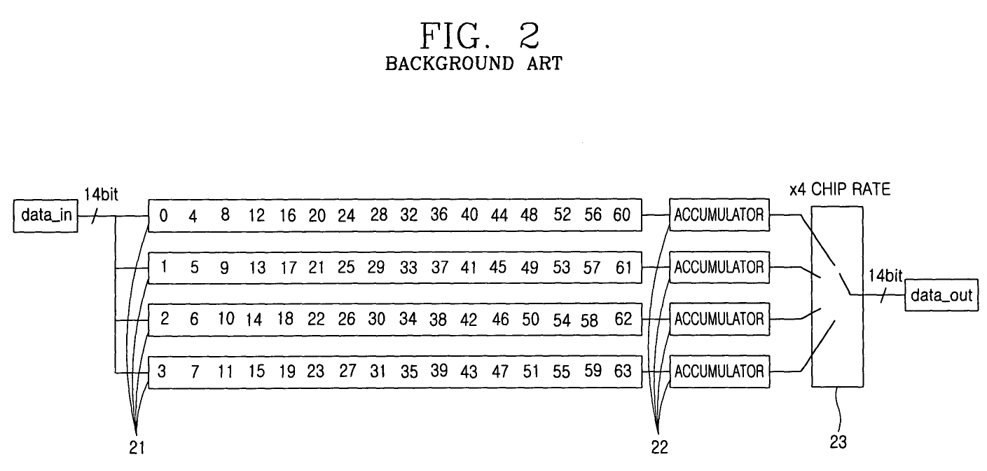

FIG. 3 is a block diagram showing an exemplary configuration of a digital filter in a mobile communication terminal according to the present invention;

FIG. 4 is a block diagram showing an exemplary configuration of a sub-filter shown in FIG. 3;

FIG. 5 is a flow chart illustrating an exemplary operating method of the digital filter according to the present invention; and

FIG. 6 is an exemplary view for illustrating operations of the digital filter according to the present invention.

### DETAILED DESCRIPTION OF PREFERRED EMBODIMENTS

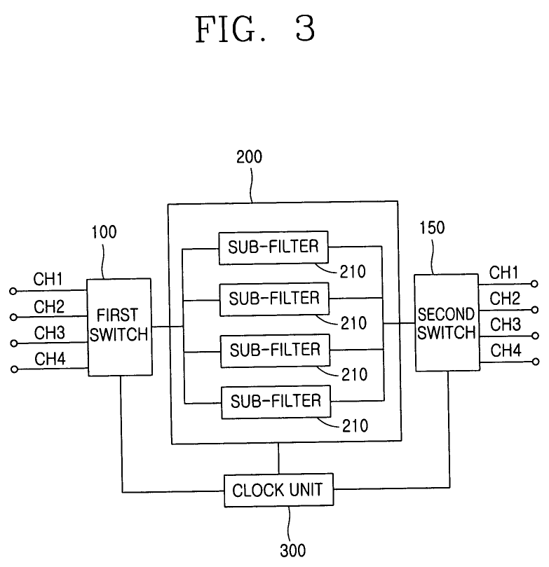

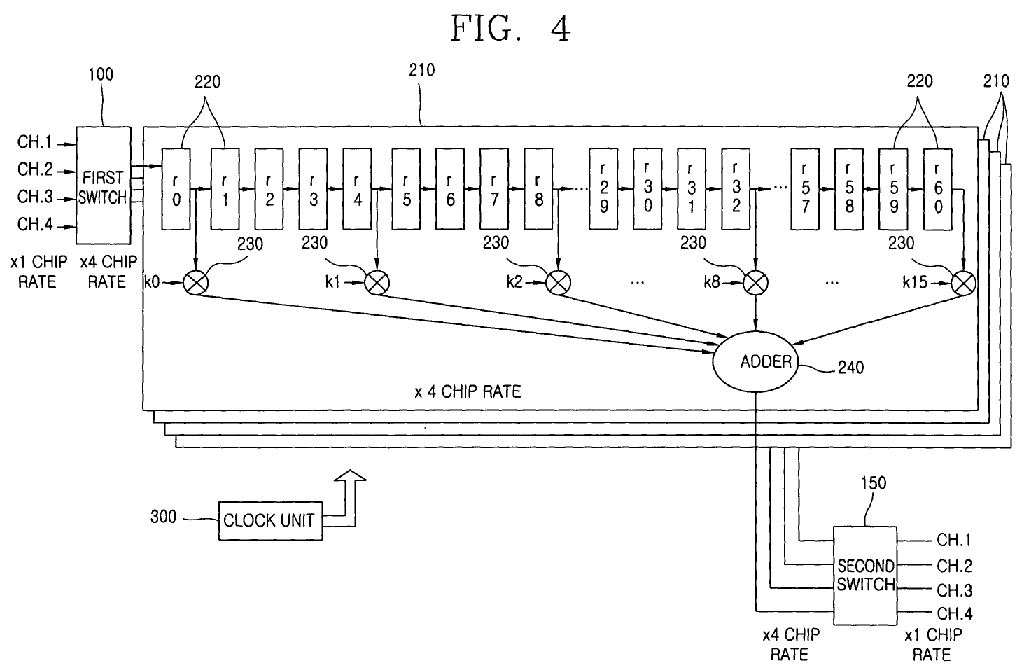

FIG. 3 is a block diagram showing an exemplary configuration of a digital filter in a mobile communication terminal according to one embodiment of the present invention, and FIG. 4 is a block diagram showing an inner structure of a sub-filter shown in FIG. 3.

As shown in FIG. 3, the digital filter according to one embodiment of the present invention comprises: a first switch 100 for switching respective digital signals inputted through a plurality of channels in a predetermined order and outputting them selectively; a filter unit 200 for filtering the respective digital signals inputted from the first switch 100 in a poly-phase method; a second switch 150 for dividing and outputting signals outputted from the filter unit 200 by channels; and a clock unit 300 for supplying clock signals to the first switch 100, the second switch 150 and to the filter unit 200.

The first switch 100 switches the digital signals, which are inputted from a plurality of channel paths in ×1 chip rate, with a rate multiplied by the number of channels. At that time, the first switch 100 time-division multiplexes the digital signals of ×1 chip rate to arrange the data corresponding to the same time in order of channel 1, channel 2, channel 3 and channel 4 in parallel. The filter unit 200 includes a plurality of sub-filters 210 for simultaneously filtering the digital signals inputted from the first switch 100 in poly-phase method.

As shown in FIG. 4, the sub-filter 210 comprises: a plurality of registers 220 repeatedly inputting and storing the digital signals inputted from the first switch 1000 sequentially; a plurality of multipliers 230 multiplying signals inputted to the respective channel units from the registers 220 by respective coefficient; and an adder 240 for adding the output signals of the multiplier 230. The sub-filters 210 connected to the channels 1 through 4 are configured to be same as the above.

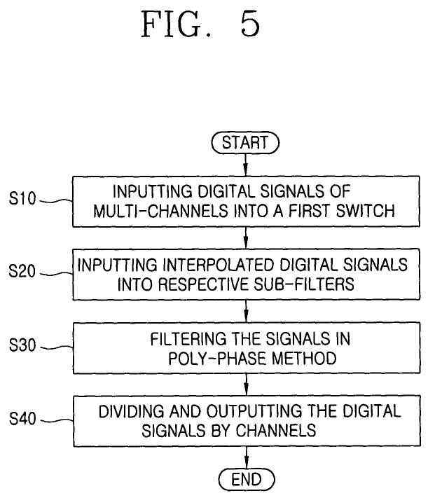

FIG. 5 is a flow chart illustrating an exemplary operating method of the digital filter in the mobile terminal according to one embodiment of the present invention. The digital signals are inputted into the first switch 100 by respective channels through the plurality of channel paths (S11), and the first switch 100 switches the digital signal of ×1 chip rate inputted by channels in ×4 chips rate to output the signals to the respective sub-filters 210 in order of channel 1, channel 2, channel 3 and channel 4 (S12). At that time, the digital signal of the respective channel is interpolated and supplied to the four sub-filters 210 sequentially.

The digital signal outputted from the first switch 100 is inputted into the respective sub-filter 210 of the filter unit 200 and filtered in poly-phase method according to the clock signal supplied from the clock unit 300 (S13), and after that, divided by channels in the second switch 150 and outputted (S14). At that time, the filter unit 200 and the second switch 150 performs the filtering and dividing by channels based on the clock signal inputted from the clock unit 150.

Generally, in the case of the mobile communication system using a CDMA method, one communication channel inputted from respective users can be divided into I-signal and Q-signal, and therefore, one channel path increases to two channels. In the case where the user usage channels are four, the channels increase to 8 channel paths since the respective channels are divided into the I-signal channels and Q-signal channels.

The respective channel paths as described above require the digital filter, and therefore, the digital filters required by the plurality of channel paths can be configured simply according to the present invention, and at the same time, signal processing rate can be improved.

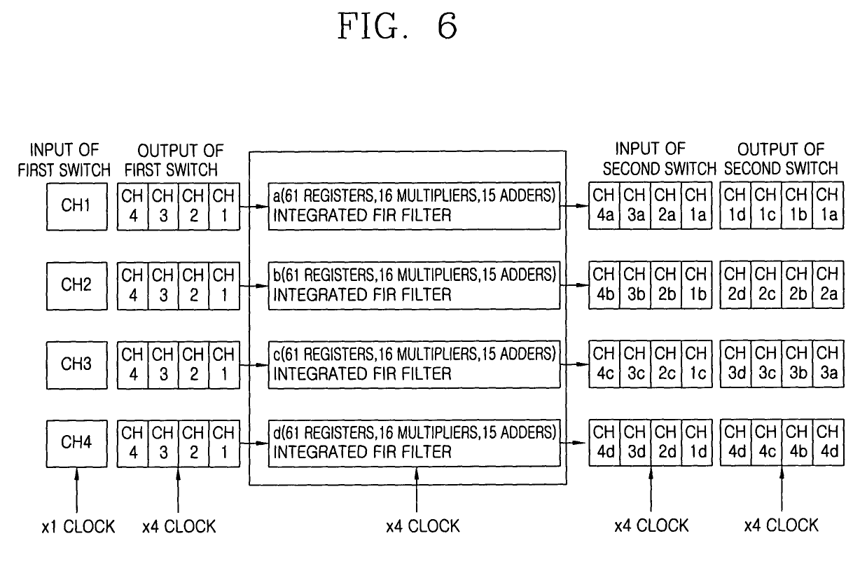

FIG. 6 is an exemplary view for describing operations of the digital filter in the mobile communication terminal according to the present invention, and the operation of the digital filter will be described in detail with reference to FIG. 6.

The first switch 100 performs the interpolation process with the digital signals received from the four channels based on the clock signal of ×4 chip rate, and the interpolated digital signals are switched sequentially to the four sub-filters 210 constructing the filter unit. The digital signals inputted from the channel 1 through channel 4 are switched in the first switch 100 with ×4 chip rate, and after that, outputted into the filter unit 200 in order of channel 1, channel 2, channel 3 and channel 4.

The digital signals in the order of channel 1, channel 2, channel 3 and channel 4 inputted from the first switch 100 are inputted into the respective sub-filters 210 of the filter unit 200 sequentially. At that time, the filter unit 200 filters the four channel signals with 64 taps, and uses four sub-filters 210 and performs 4 interpolations simultaneously. The sub-filters 210 comprise 16 multipliers 230 for 16 tap processing; 15 adders 240 for adding the output signals of the multipliers 230; and 61 registers (r0˜r60) processing the interpolated digital signals and storing initially inputted digital signals.

The first digital signal inputted into the sub-filter 210 is inputted into the first register (r0), and when next signal is inputted, that signal is inputted into the first register (r0) and the first digital signal in the first register (r0) is shifted to the second register (r1).

In addition, when the next digital signal is inputted, that signal is inputted into the first register (r0), and at the same time, the signal stored in the first register (r0) is shifted to the second register (r1) and the signal in the second register (r1) is shifted to the third register (r2).

In case that the signal stored in the first register (r0) is shifted to the second register (r1), the signal is also inputted to the first multiplier 230 to be multiplied by corresponding coefficient K0, and after that, supplied to the adder 240. In addition, in the case where the signal inputted in to the fifth register (r4) is shifted to the sixth register (r5), the signal is multiplied by the corresponding coefficient K1 in the second multiplier 230 and supplied to the adder 240. As described above, the process that the signal inputted to the multiplier 230 is multiplied by the corresponding coefficient and supplied to the adder 240 is repeated to the 61st register (r60).

The signal inputted into the respective registers of the sub-filter 210 and shifted is multiplied by the corresponding coefficient in the multiplier 230 and supplied to the adder 240, and then, added with the values inputted from the other multipliers and outputted to the second switch 150. The signals outputted from the four sub-filters 210 are supplied to the second switch 150 and outputted after being re-arranged by channel units. At that time, the output signals rearranged in the second switch 150 by respective channels are same as the results of a process that the digital signals inputted by channel units are passed through the respective digital filters.

As shown in FIG. 6, the signals of four channel inputted into the first switch 100 are outputted as the signals interpolated with ×4 rate by the ×4 chip clock signal received in the first switch. The interpolated digital signals of 4 channels with ×4 rate are inputted respectively to the corresponding sub-filters 210 of the filter unit 200 to be filtered in poly-phase method, and after that, inputted into the second switch 150. The signals of four channels inputted in the second switch 150 are outputted after re-arranged in same channel unit as that of the signals inputted into the first switch 100 from the second switch 150 inputted by ×4 chip clock signal.

As described above, the digital filter of the mobile communication system according to the present invention performs the functions corresponding to the four digital filters in the conventional art by using less logic gates, and therefore, the volume of the digital filter can be reduced and the price can be decreased.

Also, the digital filter of the mobile communication system according to the present invention filters the signals four times as many as those in the related art digital filters while the processing rate is the same as that of the one channel unit of ×1 chip rate. Therefore, the filtering rate of the digital signal can be increased.

In addition, according to the various embodiments of the digital filter of the mobile communication system of the present invention, the filtering rate can be further improved by using the number of the sub-filters constructing the filter unit and the clock signal.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A digital filter of a mobile communication system comprising:
a first switch outputting digital signals, which are inputted through a plurality of channel paths, in a predetermined order with multiple rate;
a filter unit processing signals inputted from the first switch in a poly-phase method;
a second switch outputting output signals of the filter unit after dividing them by channels; and
a clock unit supplying clock signals to the first switch, the filter unit and the second switch.

2. The filter of claim 1, wherein the first switch switches the digital signals, which are inputted from respective channels in certain rates, in a rate that multiplied by the number of channels.

3. The filter of claim 1, wherein the filter unit comprises a plurality of sub-filters as many as the number of the channels.

4. The filter of claim 3, wherein the sub-filter comprises:
a plurality of registers shifting the digital signals inputted from the first switch sequentially;
a plurality of multipliers for multiplying the signals inputted into respective channels of the registers by respective coefficients; and
an adder for adding output signals of the multipliers.

5. The filter of claim 1, wherein the second switch divides the digital signal outputted from the filter unit so that the channel of the signal is same as that of the digital signal inputted into the first switch.

6. The filter of claim 1, wherein the clock unit supplies multiple clock signals to the first switch, the filter unit and to the second switch.

7. A digital filter of a mobile communication system comprising:
a first switch interpolating and outputting digital signals inputted in channel unit through a plurality of channel paths in multiple rate;
a filter unit including a plurality of sub-filters processing digital signals inputted from the first switch in a poly-phase method;
a second switch re-arranging output signals of an adder by channels and outputting them; and
a clock unit supplying multiple clock signals to the first switch, the filter unit and the second switch.

8. The filter of claim 7, wherein the first switch switches digital signals inputted in ×1 chip rate with a rate multiplied by the number of input channels.

9. The filter of claim 7, wherein the sub-filter comprises:
a plurality of registers for shifting repeatedly the digital signals inputted from the first switch;
a plurality of multipliers for multiplying the signals of channel unit inputted from the registers by corresponding coefficients; and
an adder for adding the output signals of the multipliers and outputting them.

10. The filter of claim 7, wherein the sub-filters are configured to have same structures.

11. A digital filter of a mobile communication system comprising:
a first switch interpolating digital signals inputted in ×1 chip rate through a plurality of channels and outputting after arranging them in parallel sequentially;
a plurality of registers storing and shifting the digital signals inputted from the first switch;
a plurality of multipliers multiplying the signals inputted from the registers in respective channel unit by corresponding coefficients;
an adder for adding output signals of the multipliers;
a second switch re-arranging output signals of the adder by channels and outputting them; and
a clock unit supplying clock signals of N chip rate (N is 1 or larger natural number) in order to process the digital signals.

12. The filter of claim 11, wherein the shifting is repeatedly performed till the digital signal reaches to the last register.

13. The filter of claim 11, wherein the clock signal has a rate which is a plurality of times faster than that of the inputted digital signal.

14. An operating method of a digital filter in a mobile communication system processing digital signals inputted through a plurality of channels,
wherein the digital signal is filtered in a poly-phase method based on clock signals supplied in multiple rate.

15. The method of claim 14, wherein the clock signal has a multiple larger than the number of channels.

16. An operating method of a digital filter comprising:
inputting respective digital signals through a plurality of channels;
filtering the inputted digital signals in a poly-phase method; and
re-arranging the filtered digital signals by channels and outputting them.

17. The method of claim 16, wherein the step of inputting digital signals comprises:
interpolating the digital signals inputted through the respective channel paths by multiple clock signals; and
arranging the interpolated signals sequentially and outputting them.

18. The method of claim 16, wherein the step of filtering comprises:
repeatedly inputting the digital signal based on the multiple clock signals; and
multiplying the digital signals by certain coefficients when the digital signals as many as the number of channels are inputted and adding them.

19. An operating method of a digital filter comprising:
inputting digital signals into a first switch through a plurality of channels;
outputting the digital signals inputted by channels after interpolating the signals;
repeatedly inputting the interpolated digital signals in multiple rate to filter the signals in a poly-phase method; and
dividing the filtered digital signals by channels in a second switch and outputting them.

20. A digital filter of a mobile communication system comprising:
a first device outputting digital signals which are inputted through a plurality of channel paths, in a predetermined order with multiple rate;
a filter unit processing signals inputted from the first device in a poly-phase method;
a second device outputting output signals of the filter unit after dividing them by channels; and
a clock supplying clock signals to the first device, the filter unit and the second device.

21. A digital filter of a mobile communication system comprising:
a first device interpolating and outputting digital signals inputted in channel unit through a plurality of channel paths in multiple rate;
a filter unit including a plurality of sub-filters processing digital signals inputted from the first switch in a poly-phase method;
a second device re-arranging output signals of an adder by channels and ouptting them; and
a clock supplying multiple clock signals to the first device, the filter unit and the second device.

22. A digital filter of a mobile communication system comprising:
a first device interpolating digital signals inputted in ×1 chip rate through a plurality of channels and outputting after arranging them in parallel sequentially;
a plurality of registers storing and shifting the digital signals inputted from the first switch;
a plurality of multipliers multiplying the signals inputted from the registers in respective channel unit by corresponding coefficients;
an adder for adding output signals of the multipliers;
a second device re-arranging output signals of the adder by channels and outputting them; and
a clock supplying clock signals of N chip rate (N is 1 or larger natural number) in order to process the digital signals.

23. An operating method of a digital filter comprising:
inputting digital signals into a first device through a plurality of channels;
outputting the digital signals inputted by channels after interpolating the signals;
repeatedly inputting the interpolated digital signals in multiple rate to filter the signals in a poly-phase method; and
dividing the filtered digital signals by channels in a second device and outputting them.
